(19) United States
(12) Patent Application Publication
(10) Pub. No.: US 2015/0192160 A1
(43) Pub. Date: Jul. 9, 2015

(54) CONNECTING ASSEMBLY AND ELECTRONIC DEVICE WITH THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventor: HAI-TAO GONG, Shenzhen (CN)

(21) Appl. No.: 14/525,653

(22) Filed: Oct. 28, 2014

(30) Foreign Application Priority Data
Jan. 8, 2014 (CN) 201410007841.5

(51) Int. Cl. F16B 19/00

(52) U.S. Cl. CPC F16B 19/002

(57) ABSTRACT

A connecting assembly includes a locking member and a latching member. The locking member includes a rod and a resisting member. The resisting member protrudes from the peripheral surface of the rod to prevent the rod from disengaging from a through hole of a first device. The latching member includes a main body and a rotatable member. The main body is fixed to the rod. The main body and the resisting member are apart from each other with a first preset distance. The rotatable member includes a supporting member and a limiting member. The supporting member is fixed to the main body. The limiting member is fixed to the supporting member, and the limiting member and the main body are apart from each other with a second preset distance.

### CROSS-REFERENCE TO RELATED APPLICATIONS

This application claims priority to Chinese Patent Application No. 201410007841.5 filed on Jan. 08, 2014, the contents of which are incorporated by reference herein.

### FIELD

The subject matter herein generally relates to connecting assemblies, and particularly, to a connecting assembly capable of shock absorption.

### BACKGROUND

A structure consisting of an elastic member is employed to connect a first device to a second device, such as connect a fan to a bracket of an electronic device.

### BRIEF DESCRIPTION OF THE DRAWINGS

Implementations of the present technology will now be described, by way of example only, with reference to the attached figures.

FIG. 1 is an isometric view showing an embodiment of an electronic device.

FIG. 2 is an exploded, isometric view showing the electronic device of FIG. 1.

FIG. 3 is an isometric view showing an embodiment of a connecting assembly of the electronic device of FIG. 1.

FIG. 4 is similar to FIG. 3, but viewed from another angle.

FIG. 5 is an exploded, isometric view showing an embodiment of the connecting assembly of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described in relation to the accompanying drawings.

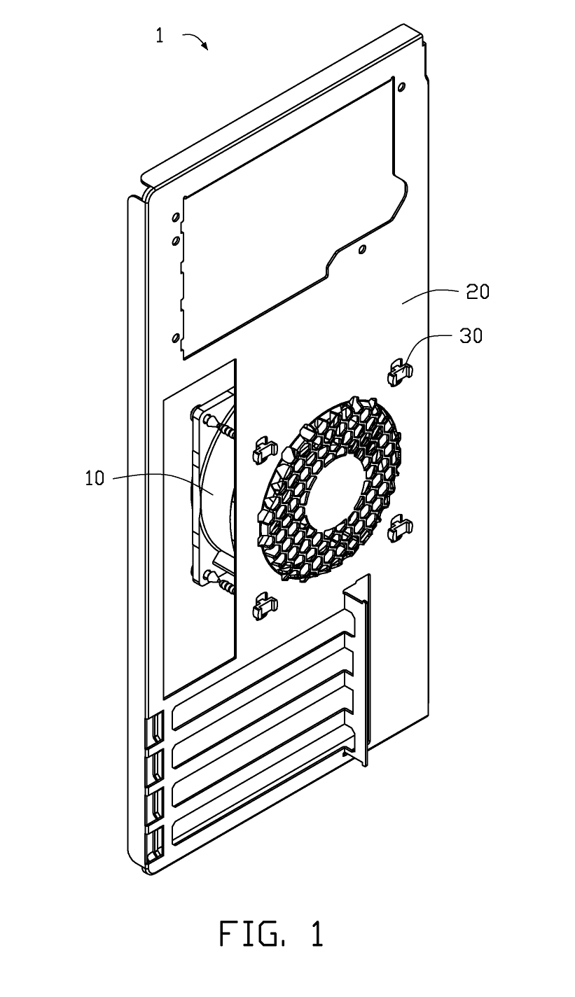

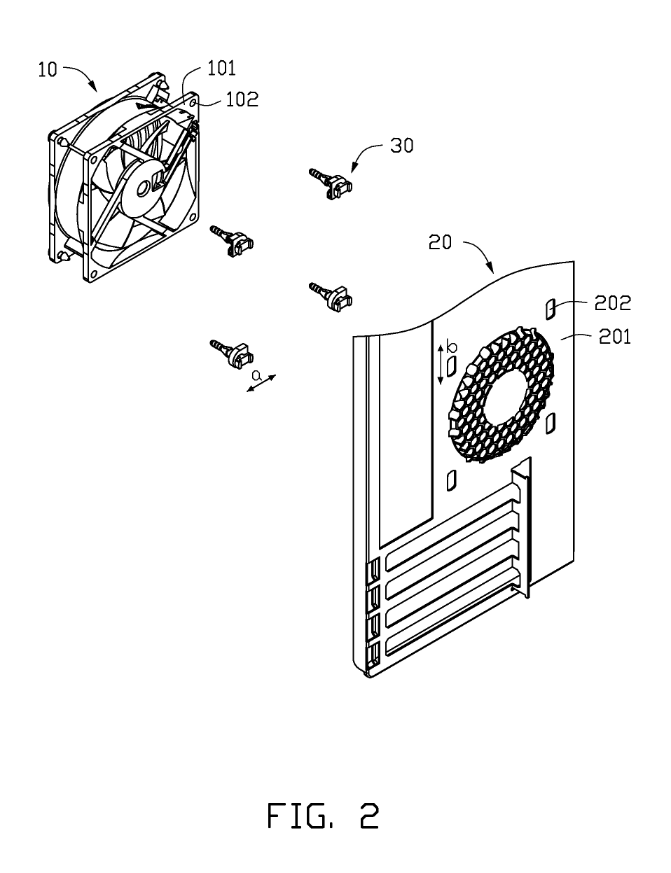

FIGS. 1-2 illustrate an embodiment of an electronic device 1. The electronic device 1 includes at least one first device 10, a second device 20, and at least one connecting assembly 30. For simplicity, one first device 10 and one connecting assembly 30 will be described in detail below. It is understood that the first devices 10 included in the electronic device 1 are mutually analogous and the connecting assemblies 30 included in the electronic device 1 are mutually analogous. In the embodiment, the first device 10 is a fan 10, and the second device 20 is a bracket 20. The fan 10 includes a housing 101 defining at least one through hole 102. The bracket 20 includes a main body 201 defining at least one slot 202. For simplicity, one through hole 102 and one slot 202 will be described in detail below. The connecting assembly 30 can connect the fan 10 to the bracket 20 via the through hole 102 and the slot 202.

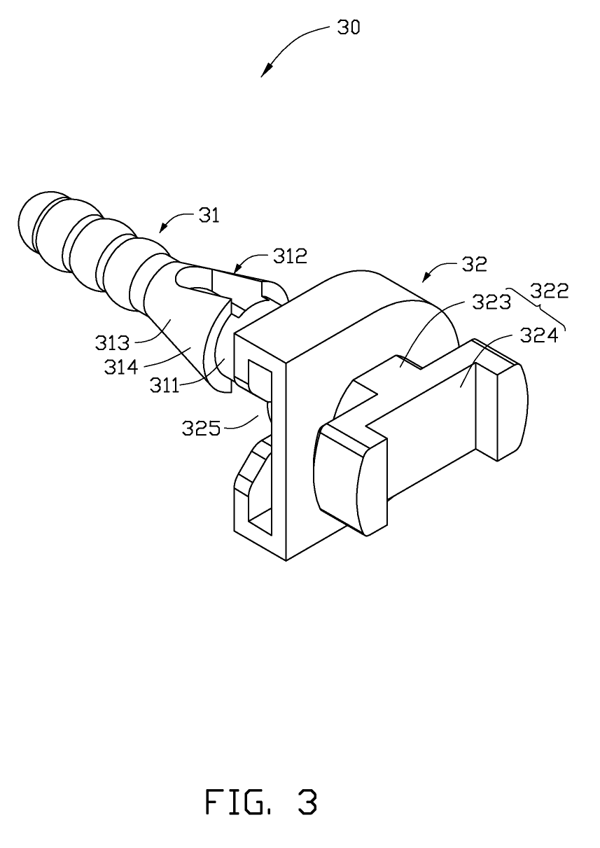

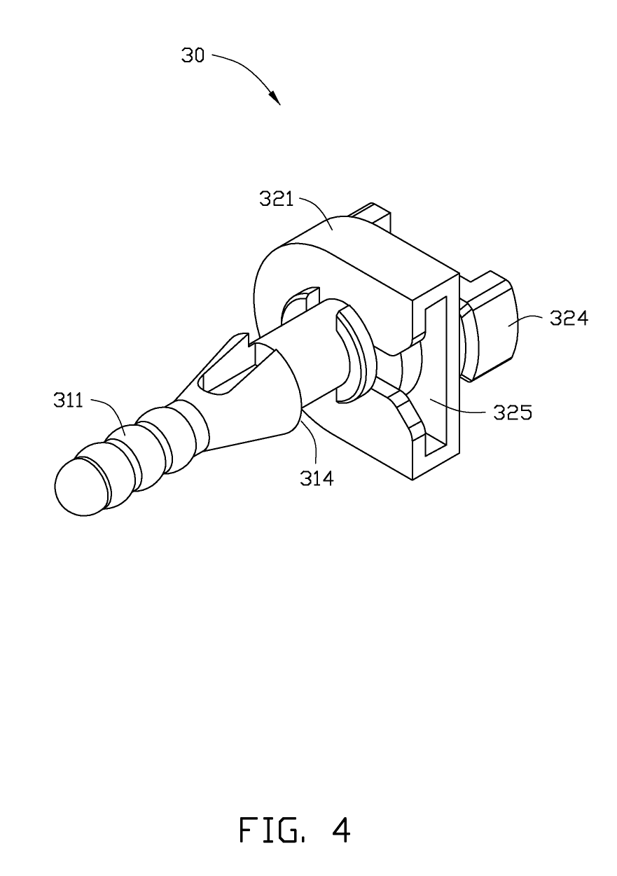

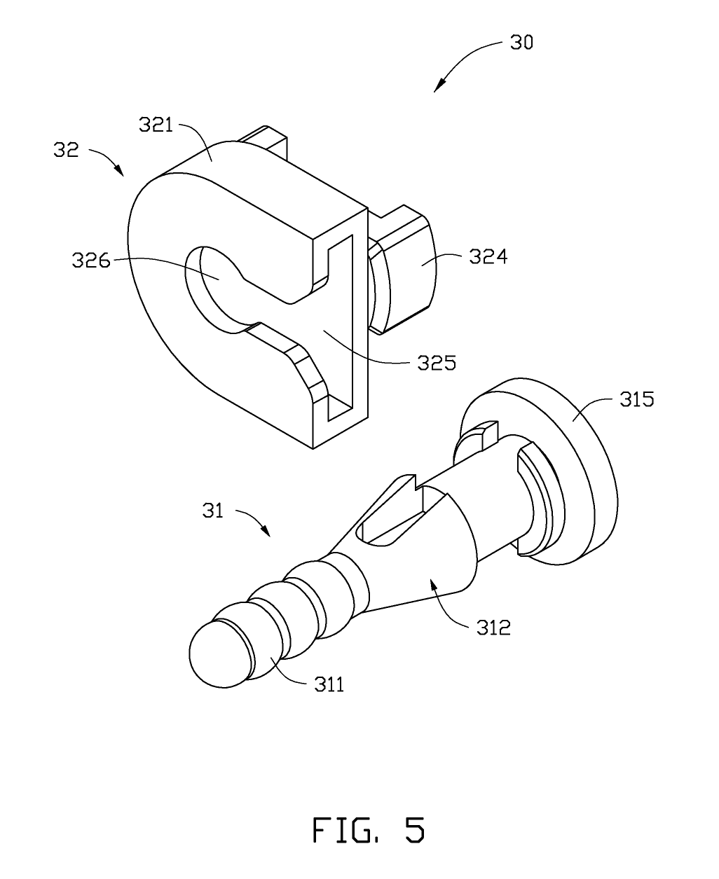

In the embodiment, the connecting assembly 30 can be made of a rubber material or a polyethylene material. FIGS. 3-5 show an embodiment of the connecting assembly 30. The connecting assembly 30 can include a locking member 31 and a latching member 32 fixed to the locking member 31. The locking member 31 can include a rod 311 and a resisting member 312. The resisting member 312 can protrude in a radial direction from a peripheral surface of the rod 311. In the embodiment, a shape of the resisting member 312 is a cone 313. A size of an end 314 of the resisting member 312 which is adjacent to the latching member 32 can be greater than a size of the through hole 102. When the resisting member 312 is passing through the through hole 102, the end 314 of the resisting member 312 is exerted by the through hole 102 and is deformed to become smaller. When the resisting member 312 passes through the through hole 102, the end 314 of the resisting member 312 rebounds and resists the housing 101 of the fan 10, which prevents the rod 311 from disengaging from the through hole 102.

The latching member 32 can include a main body 321 and a rotatable member 322. The main body 321 can be fixed to the rod 311. The main body 321 and the resisting member 312 can be apart from each from by a first preset distance. A thickness of the housing 101 (see FIG. 2) of the fan 10 (see FIG. 2) can be greater than the first preset distance. Thus, when the housing 101 of the fan 10 is received between the resisting member 312 and the main body 321, the resisting member 312 and the main body 321 resist the opposite sides of the housing 101 of the fan 10, and the housing 101 of the fan 10 is accordingly limited between the resisting member 312 and the main body 321. The rotatable member 322 can include a supporting member 323 and a limiting member 324. The supporting member 323 can be fixed to the main body 321, and the limiting member 324 can be fixed to the supporting member 323. The limiting member 324 and the main body 321 can be apart from each other by a second preset distance, and a thickness of the main body 201 (see FIG. 2) of the bracket 20 (see FIG. 2) can be greater than the second preset distance. Thus, when the main body 201 of the bracket 20 is received between the limiting member 324 and the main body 321, the limiting member 324 and the main body 321 resist the opposite sides of the main body 201 of the bracket 20, and the main body 201 of the bracket 20 is accordingly limited between the limiting member 324 and the main body 321.

When connecting the fan 10 to the bracket 20, the locking member 31 is pushed to pass through the through hole 102 of the fan 10 until the resisting member 312 passes through the through hole 102, the resisting member 312 and the main body 321 can resist opposite sides of the housing 101 of the fan 10, causing the housing 101 of the fan 10 to be limited between the resisting member 312 and the main body 321 (see FIG. 2). During this process, it must be mentioned that the alignment of the limiting member 324 is the same as the alignment of the slot 202 of the bracket 20. For example, as in FIG. 2, during connecting fan 10 to the bracket 20, a length direction “a” of the limiting member 324 and a length direction “b” of the slot 202 are both in a vertical direction. The limiting member 324 is pushed to pass through the slot 202 and the limiting member 324 is further rotated substantially 90 degrees to bring the connecting assembly 30 to rotate substantially 90 degrees, the limiting member 324 and the main body 321 can resist the opposite sides of the main body 201 of the bracket 20, causing the main body 201 of the bracket 20 to be limited between the limiting member 324 and the main body 321. Thus, the connecting assembly 30 can connect the fan 10 to the bracket 20 (see FIG. 2).

In the embodiment, the locking member 31 can further include a head 315. The rod 311 can substantially perpendicularly protrude from the head 315. The main body 321 can define an opening 325 and a receiving room 326. The opening 325 can be coupled to the receiving room 326. A size of the receiving room 326 can be less that a size of the head 315. Since the head 315 is made of a rubber material or a polyethylene material, the head 315 can be exerted to be deformed and accordingly limited in the receiving room 326 when the head 315 enters into the receiving room 326 via the opening 325, thus the main body 321 is fixed to the rod 311 via the head 315.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A connecting assembly comprising:
a locking member comprising a rod and a resisting member, the resisting member protruding from the peripheral surface of the rod to prevent the rod from disengaging from a through hole of a first device; and
a latching member comprising a main body and a rotatable member, the main body being fixed to the rod, the main body and the resisting member being apart from each other by a first preset distance; the rotatable member comprising a supporting member and a limiting member, the supporting member being fixed to the main body, the limiting member being fixed to the supporting member, and the limiting member and the main body being apart from each other by a second preset distance;
wherein the rod is pushed to pass through the through hole of the first device until the resisting member passes through the through hole of the first device, the resisting member and the main body is configured to resist opposite sides of a housing of the first device and limit the housing of the first device therein; the limiting member is pushed to pass through a slot of a second device and is rotated, the limiting member and the main body is configured to resist opposite sides of a main body of the second device and limit the main body of the second device therein, connecting the first device to the second device.

2. The connecting assembly as described in claim 1, wherein the connecting assembly is made of a rubber material or a polyethylene material.

3. The connecting assembly as described in claim 2, wherein the first preset distance is configured to less than a thickness of the housing of the first device.

4. The connecting assembly as described in claim 2, wherein the second preset distance is configured to less than a thickness of the main body of the second device.

5. The connecting assembly as described in claim 2, wherein the locking member further comprises a head, the rod substantially perpendicularly protrudes from the head; the main body defines an opening and a receiving room, the opening is coupled to the receiving room, a size of the receiving room is less than a size of the head; the head is exerted to be deformed and accordingly limited in the receiving room when the head enters into the receiving room via the opening.

6. The connecting assembly as described in claim 1, wherein the shape of the resisting member is a cone, a size of an end of the resisting member which is adjacent to the latching member is configured to be greater than a size of the through hole, the end of the resisting member is configured to be exerted by the through hole to be deformed when the resisting member is passing through the through hole, and the end of the resisting member rebounds and is configured to resist the housing of the first device when the resisting member passes through the through hole.

7. An electronic device comprising:
at least one first device, each of the at least one first device comprising a housing defining a through hole;
a second device comprising a main body defining a slot; and
at least one connecting assembly, each of the at least one connecting assembly comprising:
a locking member comprising a rod and a resisting member, the resisting member protruding from the peripheral surface of the rod to prevent the rod from disengaging from the through hole of the first device; and
a latching member comprising a main body and a rotatable member, the main body being fixed to the rod, the main body and the resisting member being apart from each other with a first preset distance; the rotatable member comprising a supporting member and a limiting member, the supporting member being fixed to the main body, the limiting member being fixed to the supporting member, and the limiting member and the main body being apart from each other with a second preset distance;
wherein the rod is pushed to pass through the through hole of one of the at least one first device until the resisting member passes through the through hole of the one of the at least one first device, the resisting member and the main body resist opposite sides of the housing of the one of the at least one first device and limit the housing of the one of the at least one first device therein; the limiting member is pushed to pass through the slot of the second device and is rotated, the limiting member and the main body resist opposite sides of the main body of the second device and limit the main body of the second device therein, connecting the one of the at least one first device to the second device.

8. The electronic device as described in claim 7, wherein each of the at least one connecting assembly is made of a rubber material or a polyethylene material.

9. The electronic device as described in claim 8, wherein a thickness of the housing of each of the at least one first device is greater than the first preset distance.

10. The electronic device as described in claim 8, wherein a thickness of the main body of the second device is greater than the second preset distance.

11. The electronic device as described in claim 8, wherein the locking member further comprises a head, the rod substantially perpendicularly protrudes from the head; the main body defines an opening and a receiving room, the opening is coupled to the receiving room, a size of the receiving room is less than a size of the head; the head is exerted to be deformed and accordingly limited in the receiving room when the head enters into the receiving room via the opening.

12. The electronic device as described in claim 7, wherein the shape of the resisting member is a cone, a size of an end of the resisting member which is adjacent to the latching member is greater than a size of the through hole of the one of the at least one first device, the end of the resisting member is exerted by the through hole of the one of the at least one first device to be deformed when the resisting member is passing through the through hole of the one of the at least one first device, and the end of the resisting member rebounds and resists the housing of the one of the at least one first device when the resisting member passes through the through hole of the one of the at least one first device.

13. A connecting assembly comprising:
a locking member comprising a rod and a resisting member, the resisting member protruding in a radial direction from a peripheral surface of the rod, the rod and the resisting member being configured to pass through a through hole of a first device, the resisting member being configured to engage a first side of a housing of the first device; and
a latching member comprising:
a main body that slidably receives the locking member, the main body and the resisting member being spaced apart from each other by a first preset distance when assembled, the main body being configured to engage a second side of the housing of the first device, the second side of the housing being opposite to the first side of the housing; and
a rotatable member comprising a supporting member fixed to the main body and a limiting member fixed to the supporting member, the limiting member and the main body being spaced apart from each other by a second preset distance, the limiting member being configured to pass through a slot in a second device, the limiting member and the main body being configured to engage opposite sides of a main body of the second device, the locking member and the latching member being adapted to connect the first device and the second device.

14. The connecting assembly as described in claim 13, wherein the connecting assembly is made of a rubber material or a polyethylene material.

15. The connecting assembly as described in claim 14, wherein the first preset distance is configured to less than a thickness of the housing of the first device.

16. The connecting assembly as described in claim 14, wherein the second preset distance is configured to less than a thickness of the main body of the second device.

17. The connecting assembly as described in claim 14, wherein the locking member further comprises a head, the rod substantially perpendicularly protrudes from the head; the main body defines an opening and a receiving room, the opening is coupled to the receiving room, a size of the receiving room is less than a size of the head; the head is exerted to be deformed and accordingly limited in the receiving room when the head enters into the receiving room via the opening.

18. The connecting assembly as described in claim 13, wherein the shape of the resisting member is a cone, a size of an end of the resisting member which is adjacent to the latching member is configured to be greater than a size of the through hole, the end of the resisting member is configured to be exerted by the through hole to be deformed when the resisting member is passing through the through hole, and the end of the resisting member rebounds and is configured to resist the housing of the first device when the resisting member passes through the through hole.
